(19) United States
(12) Patent Application Publication
(10) Pub. No.: US 2026/0168625 A1
(43) Pub. Date: Jun. 18, 2026

(54) GAS SUPPLY SYSTEM

(71) Applicant: TOYOTA JIDOSHA KABUSHIKI KAISHA, Toyota-shi (JP)

(72) Inventors: Naoki TOMI, Kawasaki-shi (JP); Tetsuya Tonosako, Fuji-shi (JP); Yoshikatsu Fujimura, Toyota-shi (JP)

(73) Assignee: TOYOTA JIDOSHA KABUSHIKI KAISHA, Toyota-shi (JP)

(21) Appl. No.: 19/332,293

(22) Filed: Sep. 18, 2025

(30) Foreign Application Priority Data
Dec. 16, 2024 (JP) 2024-219673

(51) Int. Cl. F17C 13/02

(52) U.S. Cl. CPC F17C 13/025; F17C 2221/012; F17C 2223/035; F17C 2250/032; F17C 2250/0434; F17C 2250/072; F17C 2260/038

(57) ABSTRACT

When a gas supply pipe approaches a gas tank of a gas supply system, a self-closing valve opens. A sealing seals a connection space including the self-closing valve and a distal end of the gas supply pipe when a distance between the self-closing valve and the gas supply pipe is equal to or less than a threshold value distance. A controller moves the gas tank backward to a position where the self-closing valve closes while maintaining the sealing of the connection space, and when internal pressure of the gas supply pipe decreases, outputs a gas leak signal indicating a gas leak other than at a check valve. Otherwise, the controller moves the gas tank backward to a position where the connection space is unsealed, and when the internal pressure of the gas supply pipe drops, outputs a check valve abnormality signal indicating a gas leak at the check valve.

### CROSS-REFERENCE TO RELATED APPLICATION

This application claims priority to Japanese Patent Application No. 2024-219673 filed on December 16, 2024. The disclosure of the above-identified application, including the specification, drawings, and claims, is incorporated by reference herein in its entirety.

### BACKGROUND

### 1. Technical Field

The technology that is disclosed in the present specification relates to a gas supply system that supplies gas in a gas tank to a gas utilizing device.

### 2. Description of Related Art

Japanese Unexamined Patent Application Publication No. 2020-174019 (JP 2020-174019 A) discloses a gas supply system that is equipped with a plurality of gas tanks and supplies gas from the gas tanks to a gas utilizing device. In the gas supply system according to JP 2020-174019 A, a check valve is provided in a gas supply pipe that sends gas from a gas tank to the gas utilizing device. JP 2020-174019 A discloses checking processing for checking whether the check valve is normal.

### SUMMARY

It is conceivable that gas may leak from places other than the check valve. The present specification provides a gas supply system capable of both checking a check valve and checking for gas leaks at other than the check valve.

A gas supply system that is disclosed in the present specification includes a gas tank, a gas supply pipe, an actuator, a sealing, a check valve, first and second pressure sensors, and a controller. The gas tank includes a self-closing valve that opens when a push rod is pushed in and that closes when the push rod is pulled out. The gas supply pipe is connected to the gas tank. The push rod is provided at a distal end of the gas supply pipe, and the gas supply pipe leads gas from the gas tank to a gas utilizing device. The actuator moves the gas tank forward and backward relative to the gas supply pipe. The sealing seals off a connection space including an opening of the self-closing valve and the distal end of the gas supply pipe, when a distance between the self-closing valve and the push rod is shorter than a predetermined threshold value distance. The check valve is provided in the gas supply pipe and suppresses backflow of gas. The first pressure sensor measures a pressure in the gas supply pipe upstream of the check valve. The second pressure sensor measures a pressure in the gas supply pipe downstream of the check valve.

When replacing a gas tank in a state in which a gas supply pipe is connected and an automatic closing valve is open, the controller executes the following processing. (1) The controller moves the gas tank backward to a position where the self-closing valve is closed while maintaining the sealing of the connection space. (2) The controller reduces a predetermined amount of gas from the gas supply pipe on a downstream side of the check valve. Note that the controller may reduce the amount of gas in the gas supply pipe by activating a gas utilizing device, or may reduce the amount of gas in the gas supply pipe by transferring the gas to a sub-tank for temporary gas storage or the like. Also, when the gas does not affect the environment, the controller may release a predetermined amount of gas into the atmosphere. (3) When an amount of decrease in a measurement value of the first or the second pressure sensor, before and after a first amount of time elapses, exceeds a predetermined first differential pressure threshold value, the controller outputs a gas leak signal indicating that a gas leak is occurring at a location other than the check valve. The processing of (3) checks whether a gas leak is occurring at a location other than the check valve. (4) When the measurement value of the first or the second pressure sensor before and after the first amount of time elapses does not exceed the first differential pressure threshold value, the controller moves the gas tank backward to a position where the sealing of the connection space is disengaged. (5) when the amount of decrease in the measurement value of the second pressure sensor before and after a second amount of time elapses exceeds a second differential pressure threshold value, the controller outputs a check valve abnormality signal indicating that a gas leak is occurring at the check valve, and also moves the gas tank forward to a position where the connection space is sealed. The processing of (5) checks whether a gas leak is occurring at the check valve. A gas supply system that is disclosed in the present specification is capable of both checking a check valve and checking for gas leaks at other than the check valve.

Details of the technology disclosed in the present specification and further improvements will be described in the "DETAILED DESCRIPTION OF EMBODIMENTS" below.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram of a gas supply system according to an embodiment;

FIG. 2 is a cross-sectional view of a gas tank and a gas supply pipe (sealing position);

FIG. 3 is a cross-sectional view of the gas tank and the gas supply pipe (open valve position);

FIG. 4 is a flowchart of gas leak check processing; and

FIG. 5 is a flowchart of the gas leak check processing (continuation of FIG. 4).

### DETAILED DESCRIPTION OF EMBODIMENTS

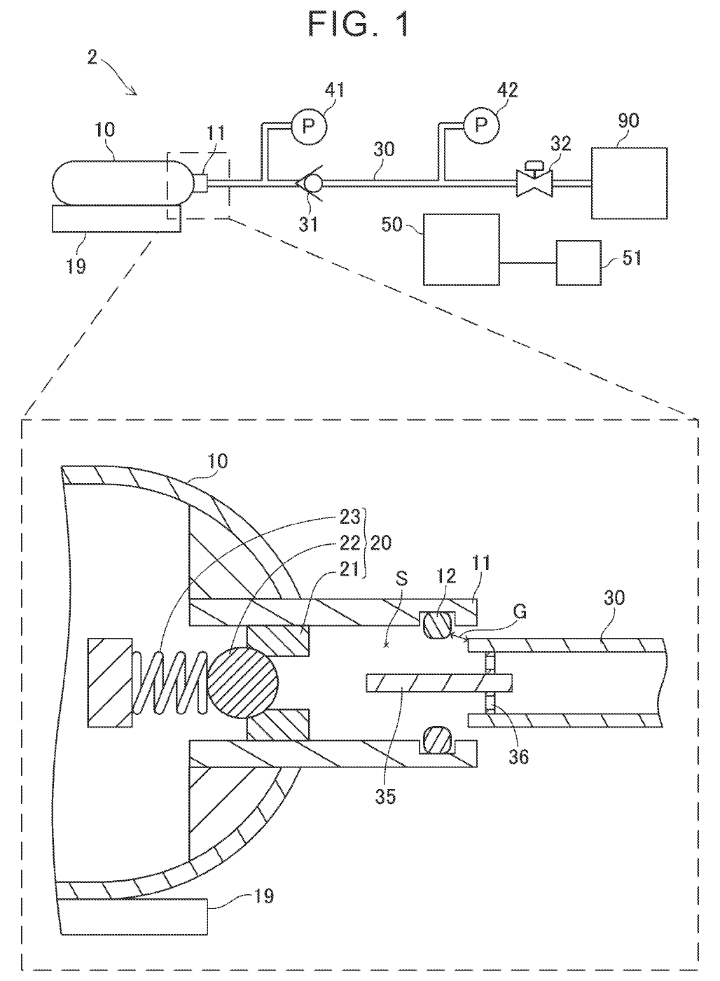

A gas supply system 2 according to an embodiment will be described with reference to the drawings. FIG. 1 is a block diagram of the gas supply system 2. A fuel cell 90 is connected to the gas supply system 2 according to the embodiment, and the gas supply system 2 supplies hydrogen gas from a gas tank 10 to the fuel cell 90. The fuel cell 90 is an example of a gas utilizing device to which the gas supply system 2 supplies gas.

The gas supply system 2 includes the gas tank 10, a gas supply pipe 30, a push rod 35, an actuator 19, a first pressure sensor 41, a second pressure sensor 42, a check valve 31, a controller 50, and a display device 51.

The gas tank 10 is filled with high-pressure hydrogen gas. The gas tank 10 and the fuel cell 90 are connected by the gas supply pipe 30. The gas supply pipe 30 leads the hydrogen gas in the gas tank 10 to the fuel cell 90. The check valve 31 and a pressure reducing valve 32 are connected to the gas supply pipe 30. The pressure reducing valve 32 is disposed downstream of the check valve 31. Here, the term "downstream" refers to a side of the gas supply pipe 30 that is closer to the fuel cell 90 (gas utilizing device), and the term "upstream" refers to a side thereof that is closer to the gas tank 10.

The pressure reducing valve 32 reduces pressure of the hydrogen gas that is supplied from the gas tank 10 to a pressure that is suitable for operation of the fuel cell 90. That is to say, the gas pressure that is suitable for operation of the fuel cell 90 is lower than the pressure of the gas that is supplied from the gas tank 10.

The check valve 31 allows gas to pass from upstream to downstream, and keeps gas from flowing from downstream to upstream. The check valve 31 suppresses hydrogen gas from leaking to the outside from downstream of the check valve 31, in a case in which a gas leak occurs at a connection point between the gas tank 10 and the gas supply pipe 30.

The first pressure sensor 41 measures pressure in the gas supply pipe 30 upstream of the check valve 31. When the gas tank 10 is connected to the gas supply pipe 30, a measurement value of the first pressure sensor 41 is approximately equal to internal pressure of the gas tank 10 (the measurement value of the first pressure sensor 41 will be lower than the internal tank pressure by the amount of pressure loss due to a self-closing valve 20 and so forth, which will be described later).

The second pressure sensor 42 measures pressure in the gas supply pipe 30 downstream of the check valve 31. While gas is being supplied from the gas tank 10, a measurement value of the second pressure sensor 42 is substantially equal to the measurement value of the first pressure sensor 41 (the measurement value of the second pressure sensor 42 will be lower than the measurement value of the first pressure sensor 41 by an amount corresponding to a pressure loss due to the check valve 31, and so forth).

A cross-sectional view of a neck 11 of the gas tank 10 and a distal end of the gas supply pipe 30 is illustrated on the lower side of FIG. 1. The neck 11 of the gas tank 10 includes the self-closing valve 20. The self-closing valve 20 includes a sleeve 21, a valve body 22, and a spring 23. The sleeve 21 is attached on an inner side of the neck 11. The valve body 22 is disposed adjacently to the sleeve 21 within the tank. The spring 23 presses the valve body 22 against an opening of the sleeve 21 (opening that opens into the tank) from inside the tank. An end of the spring 23 on the other side thereof is supported by an inner wall of the tank.

The valve body 22 is in close contact with the opening of the sleeve 21, under force of the spring 23. The self-closing valve 20 is closed while the valve body 22 is in close contact with the opening of the sleeve 21. The self-closing valve 20 opens when the valve body 22 is pushed toward the inner side from the outside of the tank. When a load on the valve body 22 is removed, the force of the spring 23 causes the valve body 22 to come back into close contact with the opening of the sleeve 21, thereby closing the self-closing valve 20.

The push rod 35 is provided at the distal end of the gas supply pipe 30. The push rod 35 is fixed to the distal end of the gas supply pipe 30 by a rod support 36. The rod support 36 has holes that are provided therein, through which gas can flow from the gas tank 10 into the gas supply pipe 30.

When the gas tank 10 is set in the gas supply system 2, the push rod 35 at the distal end of the gas supply pipe 30 faces the neck 11. The actuator 19 moves the gas tank 10. The actuator 19 moves the gas tank 10 closer to and away from the gas supply pipe 30. More specifically, the actuator 19 moves the self-closing valve 20 closer to and away from the distal end of the gas supply pipe 30 (i.e., the push rod 35). The cross-sectional view in FIG. 1 illustrates a state in which the push rod 35 is away from the self-closing valve 20.

The actuator 19 moves the gas tank 10 forward and backward relative to the distal end of the gas supply pipe 30. For convenience of description, when the gas tank 10 moves closer to the gas supply pipe 30, this is referred to as "moving forward", and when the gas tank 10 moves away from the gas supply pipe 30, this is referred to as "moving backward". The actuator may move the gas supply pipe 30 forward and backward relative to the gas tank 10.

A sealing 12 is disposed inside the neck 11. When the distal end (push rod 35) of the gas supply pipe 30 moves closer to the self-closing valve 20, an outer periphery of the gas supply pipe 30 comes into contact with the sealing 12, and a space including an opening of the self-closing valve 20 (opening that opens to the outside of the gas tank 10) and the distal end of the gas supply pipe 30 is sealed off. For convenience, the space including the opening of the self-closing valve 20 and the distal end of the gas supply pipe 30 will be referred to as "connection space S". More precisely, the connection space S refers to space that is inside the neck 11 including the opening of the self-closing valve 20 and the distal end of the gas supply pipe 30. In the cross-sectional view in FIG. 1, the push rod 35 is away from the self-closing valve 20, and a gap G is maintained between the distal end of the gas supply pipe 30 and the sealing 12. In this state, the connection space S is not sealed off from the external environment.

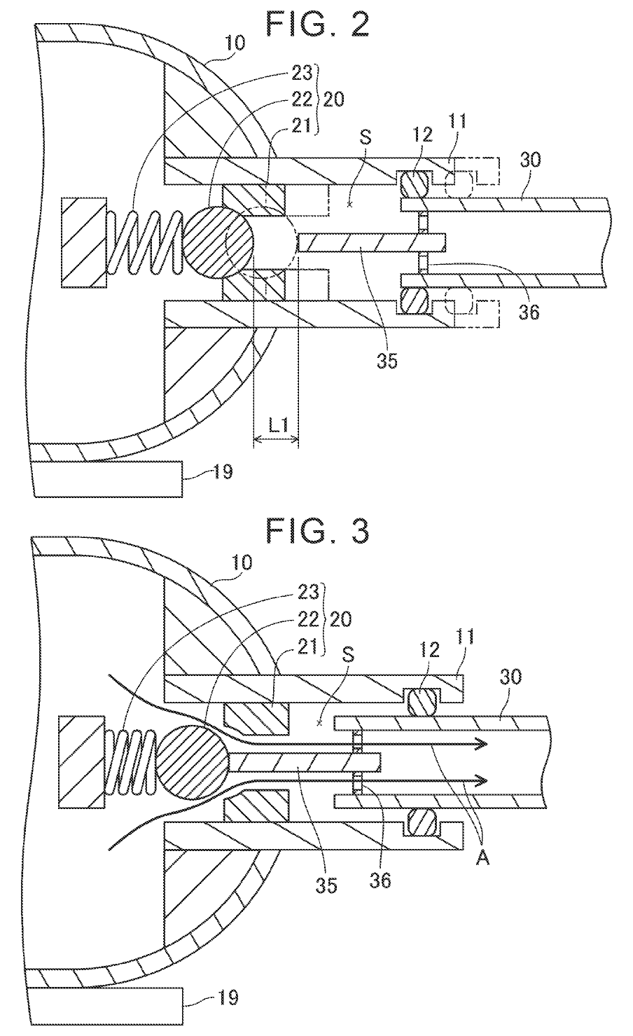

FIG. 2 illustrates a cross section in which the distal end of the gas supply pipe 30 is in contact with the sealing 12. When a distance between the push rod 35 and the self-closing valve 20 reaches L1, the sealing 12 comes into contact with the outer periphery of the gas supply pipe 30, and the connection space S is sealed off. In other words, when the distance between the push rod 35 and the valve body 22 of the self-closing valve 20 becomes shorter than L1, the connection space S is shut off from the external environment. When the distance between the push rod 35 and the valve body 22 is L1, the self-closing valve 20 remains closed. The distance L1 may be referred to as a threshold value distance.

The hidden outlines in FIG. 2 indicate a state in which the gas tank 10 has moved forward until the valve body 22 comes into contact with the distal end of the push rod 35. When the gas tank 10 moves further forward than the hidden outlines, the push rod 35 pushes the self-closing valve 20 open. FIG. 3 is a cross-sectional view in which the gas tank 10 has moved forward until the self-closing valve 20 is opened. Heavy arrows A indicate flow of the gas. While the self-closing valve 20 is open, the hydrogen gas in the gas tank 10 passes through the connection space S to the gas supply pipe 30. The connection space S is sealed off by the sealing 12, and accordingly the hydrogen gas does not leak to the outside.

The gas in the gas tank 10 passes through the self-closing valve 20 that is open, passes through the holes in the rod support 36, and flows to the gas supply pipe 30. For the convenience of description, the position of the gas tank 10 when the connection space S is sealed off but the self-closing valve 20 is closed will be referred to as "sealing position", and the position of the gas tank 10 when the connection space S is sealed off and the self-closing valve 20 is open will be referred to as "open valve position". FIG. 2 is a cross-sectional view in the sealing position, and FIG. 3 is a cross-sectional view in the open valve position. The sealing position is a situation in which the distance between the push rod 35 and the valve body 22 of the self-closing valve 20 is equal to or smaller than L1 and also greater than zero. Also, in the open valve position, the sealing 12 is in contact with the outer periphery of the gas supply pipe 30, and the connection space S remains sealed off.

As illustrated in FIG. 1, the position of the gas tank 10 when the sealing of the connection space S is disengaged and the connection space S communicates with the external environment is referred to as a detachment position.

When a new gas tank 10 is set on the actuator 19, the controller 50 (see FIG. 1) moves the gas tank 10 forward to the open position. The self-closing valve 20 opens, and the gas in the gas tank 10 flows through the check valve 31 and the pressure reducing valve 32 to the fuel cell 90. The fuel cell 90 becomes operational. The controller 50 operates the fuel cell 90.

When the remaining amount in the gas tank 10 runs low, the gas tank 10 needs to be replaced. When there is a malfunction in the check valve 31 when removing the old gas tank 10, hydrogen gas may leak to the outside. Accordingly, before the gas tank 10 is moved backward to the detachment position, the controller 50 performs gas leak check processing. That is to say, the controller 50 executes the gas leak check processing when replacing the gas tank 10 to which the gas supply pipe 30 is connected and the self-closing valve 20 is open.

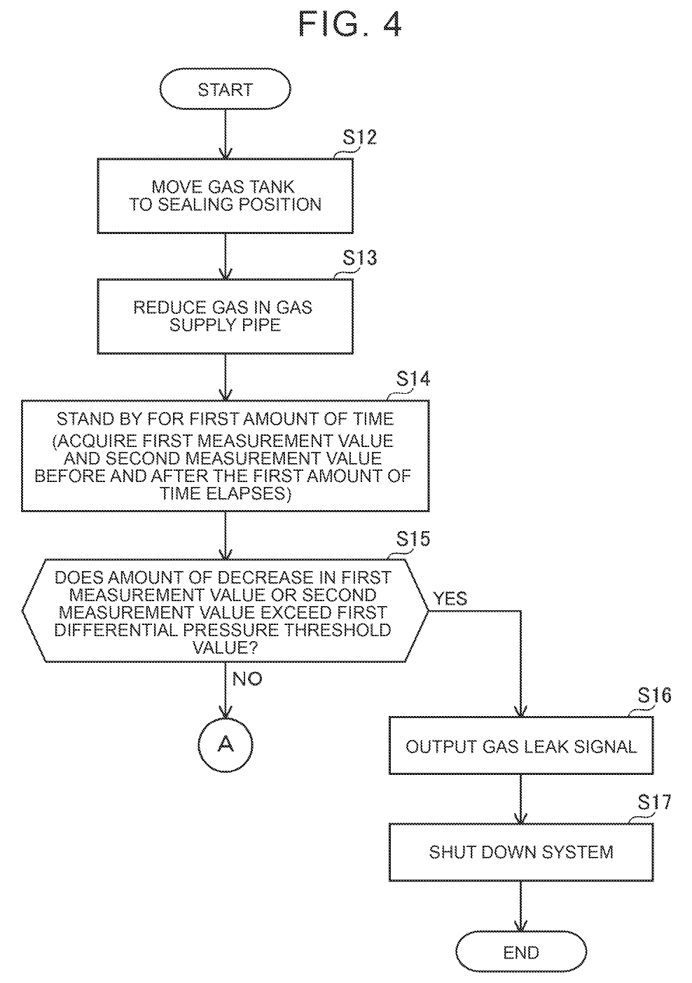

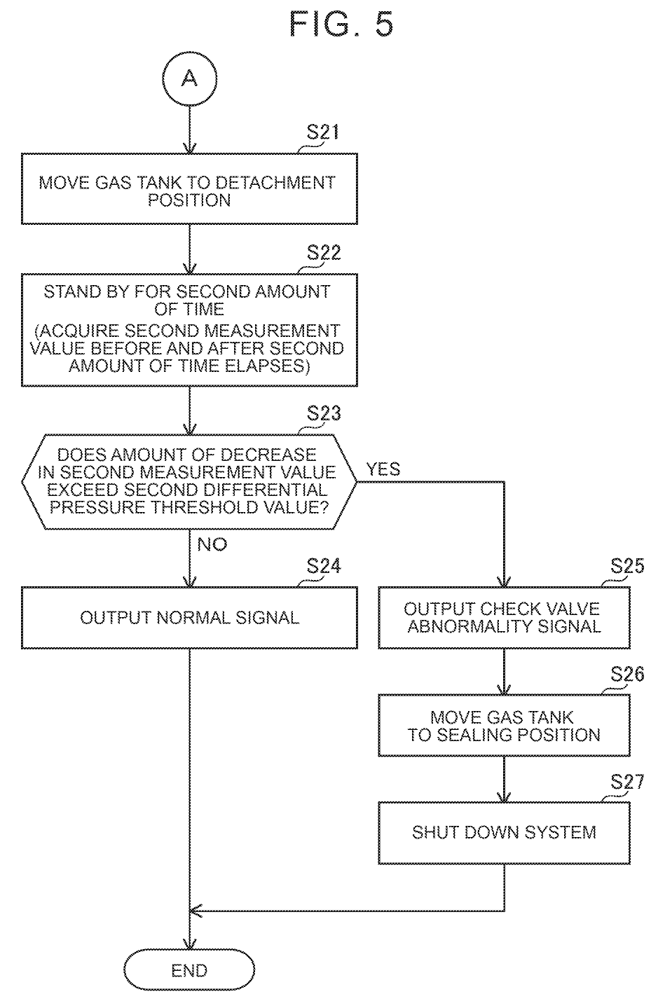

FIGS. 4 and 5 are flowcharts of the gas leak check processing that is executed by the controller 50. First, the controller 50 controls the actuator 19 to move the gas tank 10 to the sealing position (step S12). In the sealing position, the self-closing valve 20 is closed, but the connection space S is maintained in a sealed state.

Next, the controller 50 reduces a predetermined amount of gas in the gas supply pipe 30 downstream of the check valve 31 (step S13). The controller 50 may reduce the gas in the gas supply pipe 30 by operating the fuel cell 90, or may reduce the gas in the gas supply pipe 30 by transferring some of the gas in the gas supply pipe 30 to a spare tank that is omitted from illustration. Also, the controller 50 may allow a predetermined amount of the gas in the gas supply pipe 30 to be released into the atmosphere, as long as the gas does not affect the environment.

When the gas in the gas supply pipe 30 is reduced on the downstream side of the check valve 31, the pressure in the gas supply pipe 30 on the downstream side of the check valve 31 becomes lower than the pressure on the upstream side of the check valve 31. The gas on the upstream side of the check valve 31 moves to the downstream side through the check valve 31, and the pressure on the upstream side and the pressure on the downstream side of the check valve 31 become equal. That is to say, the measurement values of the first pressure sensor 41 and the second pressure sensor 42 become equal.

Next, the controller 50 stands by for a predetermined first amount of time (step S14). At this time, the controller 50 stores the measurement values of the pressure sensors 41 and 42 before and after the first amount of time elapses (step S14). Note that in the following, for the convenience of description, the measurement value of the first pressure sensor 41 (i.e., the pressure in the gas supply pipe 30 upstream of the check valve 31) will be referred to as first measurement value, and the measurement value of the second pressure sensor 42 (i.e., the pressure in the gas supply pipe 30 downstream of the check valve 31) will be referred to as second measurement value.

After the first amount of time has elapsed, the controller 50 checks whether the amount of decrease in the first measurement value before and after the first amount of time elapses, or the amount of decrease in the second measurement value before and after the first amount of time elapses, exceeds a predetermined threshold value (first differential pressure threshold value) (step S15). When the amount of decrease in the first or second measurement value, before and after the first amount of time elapses, exceeds the first differential pressure threshold value (YES in step S15), this means that gas is leaking externally from the gas supply pipe 30. At this time, the controller 50 outputs a signal (gas leak signal) indicating that a gas leak is occurring at other than the check valve 31, to the display device 51, and shuts down the gas supply system 2 and the fuel cell 90 (YES in step S15, steps S16 and S17). Upon receiving the gas leak signal, the display device 51 turns on a warning lamp (or the display device 51 emits a warning sound) indicating that a gas leak is occurring from the gas supply pipe 30 other than the check valve 31.

When the amount of decrease in the first or second measurement value before and after the first amount of time has elapsed does not exceed the first differential pressure threshold value (NO in step S15), determination is made that no gas leak is occurring other than at the check valve 31. Note that at this point in time, it is unclear whether an abnormality has occurred at the check valve 31.

When the determination in step S15 is "NO", the controller 50 moves the gas tank 10 to the detachment position (step S21). In the detachment position, the connection space S is unsealed and connected to the external environment. At this time, the first measurement value becomes equal to the atmospheric pressure.

Next, the controller 50 stands by for a predetermined second amount of time (step S22). At this time, the controller 50 stores the second measurement value (measurement value of second pressure sensor 42) before and after the second amount of time has elapsed (step S22).

After the second amount of time has elapsed, the controller 50 checks whether the amount of decrease in the second measurement value, before and after the second amount of time elapses, exceeds a predetermined threshold value (second differential pressure threshold value) (step S23). When the amount of decrease in the second measurement value, before and after the second amount of time elapses, exceeds the second differential pressure threshold value (YES in step S23), this means that gas is flowing from the downstream side to the upstream side of the check valve 31, and gas is leaking from the connection space S to the external environment. In other words, this means that an abnormality has occurred at the check valve 31. At this time, the controller 50 outputs a signal (check valve abnormality signal) indicating that gas leak is occurring at the check valve 31, to the display device 51 (step S25). Upon receiving the check valve abnormality signal, the display device 51 displays a message (or issues a warning sound) indicating that an abnormality has occurred in the check valve 31.

Furthermore, the controller 50 moves the gas tank 10 to the sealing position (step S26). By moving the gas tank 10 to the sealing position, the connection space S is sealed. Therefore, even when an abnormality is occurring in the check valve 31, the gas leak is stopped. Finally, the controller 50 shuts down the system (step S27).

When the branching determination in step S15 is "NO", finalization is made that no gas leak is occurring other than at the check valve 31. Accordingly, when the amount of decrease in the second measurement value exceeds the second differential pressure threshold value in step S23, a defect in the check valve 31 is identified as being the cause.

When the amount of decrease in the second measurement value is lower than the second differential pressure threshold value in step S23, determination is made that the check valve 31 is also normal. In this case, the controller 50 outputs a signal (normal signal) indicating that no gas leak is occurring, including from the check valve 31, to the display device 51 (NO in step S23, and step S24). The display device 51 that receives the normal signal displays a message indicating that no gas leak is occurring in the gas supply system 2, and that the gas tank 10 may be replaced. When a staff member sees the message indicating that the gas tank 10 may be replaced, the staff member replaces the gas tank 10 situated in the detachment position with a new gas tank.

The gas supply system 2 according to the embodiment can check both the check valve 31 and gas leaks other than at the check valve.

Points to be noted regarding the technology that is described in the embodiment will be described. The gas leak check processing executed by the controller 50 of the gas supply system 2 is as follows. When replacing the gas tank 10 to which the gas supply pipe 30 is connected and the self-closing valve 20 is open, the controller 50 executes the following processing. (1) The controller 50 moves the gas tank 10 backward to a position where the self-closing valve is closed (sealing position) while maintaining the sealing of the connection space S (step S12). (2) The controller 50 reduces a predetermined amount of gas from the gas supply pipe 30 downstream of the check valve 31 (step S13). Next, the controller 50 stands by for the first amount of time (step S14). At this time, the controller stores the first and second measurement values before and after the first time elapses (step S14). (3) When the amount of decrease in the measurement value of the first pressure sensor 41 or the second pressure sensor 42, before and after the first amount of time elapses, exceeds the predetermined first differential pressure threshold value, the controller 50 outputs a gas leak signal indicating that a gas leak is occurring other than at the check valve (YES in step S15, and step S16). The processing of (3) checks whether a gas leak is occurring other than at the check valve.

(4) When the amount of decrease in the measurement value of the first pressure sensor or the second pressure sensor before and after the first amount of time elapses does not exceed the first differential pressure threshold value, the controller 50 moves the gas tank 10 backward to a position (detachment position) where the sealing of the connection space S is disengaged (NO in step S15, and step S21). Next, the controller 50 stands by for the second amount of time (step S22). At this time, the controller 50 stores the second measurement value before and after the second time elapses (step S22). (5) When the amount of decrease in the measurement value of the second pressure sensor 42 before and after the second amount of time elapses exceeds the second differential pressure threshold value, the controller 50 outputs a check valve abnormality signal indicating that a gas leak is occurring at the check valve 31, and also moves the gas tank 10 forward to a position where the connection space S is sealed (sealing position) (YES in step S23, steps S25, S26). The processing of (5) checks whether a gas leak is occurring at the check valve 31. The gas supply system 2 according to the embodiment can check both the check valve 31 and gas leaks other than at the check valve.

Note that the first amount of time and the second amount of time may be from several tens of seconds to several minutes. The first amount of time and the second amount of time are set to amounts of time in which a significant pressure drop is expected to occur in the gas supply pipe 30 when a gas leak occurs.

Although specific examples of the present disclosure have been described in detail above, these examples are merely examples and do not limit the scope of claims. The technology described in the claims includes various modifications and variations of the specific examples that are exemplified above. The technical elements described in the present specification or in the drawings exhibit technical usefulness alone or in various combinations, and are not limited to the combinations described in the claims at the time of filing the application. Also, the technology exemplified in the present specification or drawings can achieve a plurality of purposes at the same time, and achieving one of the purposes itself has technical usefulness.

What is claimed is:

1. A gas supply system comprising:
a gas tank that includes a self-closing valve that opens when a push rod is pushed in and that closes when the push rod is pulled out;
a gas supply pipe to which the gas tank is connected, at a distal end of which the push rod is provided, and that leads gas from the gas tank to a gas utilizing device;
an actuator that moves the gas tank forward and backward relative to the gas supply pipe;
a sealing that seals off a connection space including an opening of the self-closing valve and the distal end of the gas supply pipe, when a distance between the self-closing valve and the push rod is shorter than a predetermined threshold value distance;
a check valve that is provided in the gas supply pipe and that suppresses backflow of gas;
a first pressure sensor that measures a pressure in the gas supply pipe upstream of the check valve;
a second pressure sensor that measures a pressure in the gas supply pipe downstream of the check valve; and
a controller, wherein
when replacing the gas tank in a state in which the gas supply pipe is connected and the self-closing valve is open, the controller
moves the gas tank backward to a position where the self-closing valve is closed while maintaining the sealing of the connection space,
reduces a predetermined amount of gas from the gas supply pipe on a downstream side of the check valve,
outputs a gas leak signal indicating that a gas leak is occurring other than at the check valve, when an amount of decrease in a measurement value of the first pressure sensor or the second pressure sensor, before and after a first amount of time elapses, exceeds a predetermined first differential pressure threshold value,
when the amount of decrease in the measurement value of the first pressure sensor or the second pressure sensor before and after the first amount of time elapses does not exceed the first differential pressure threshold value, the gas tank is moved backward to a position where the sealing of the connection space is disengaged, and
when the amount of decrease in the measurement value of the second pressure sensor before and after a second amount of time elapses exceeds a predetermined second differential pressure threshold value, a check valve abnormality signal indicating that a gas leak is occurring in the check valve is output, and also the gas tank is moved forward to a position where the connection space is sealed.
